(19) United States
(12) Patent Application Publication
(10) Pub. No.: US 2026/0292699 A1
(43) Pub. Date: Sep. 24, 2026

(54) WIRELESS COMMUNICATION METHOD, TERMINAL DEVICE, AND NETWORK DEVICE

(71) Applicant: QUECTEL WIRELESS SOLUTIONS CO., LTD., Shanghai (CN)

(72) Inventors: Ling LYU, Frisco, TX (US); Zheng ZHAO, Shanghai (CN)

(21) Appl. No.: 19/686,525

(22) Filed: May 22, 2026

Related U.S. Application Data
(63) Continuation of application No. PCT/CN2024/140366, filed on Dec. 18, 2024.

(51) Int. Cl. H04W 52/02

(52) U.S. Cl. CPC H04W 52/0235

(57) ABSTRACT

Disclosed are a wireless communication method, a terminal device, and a network device. One example method includes: receiving, by a terminal device, one or more of following transmitted by a network device: a first signal and a second signal, wherein the second signal is received based on the first signal; or the second signal; wherein at least one of the first signal or the second signal is obtained by overlaying a first sequence or a second sequence on orthogonal frequency division multiplexing (OFDM) in at least one of a time domain and a frequency domain; at least one of the first signal or the second signal is received by a first receiver of the terminal device, and power consumption of the first receiver is less than power consumption of a second receiver of the terminal device.

### CROSS-REFERENCE TO RELATED APPLICATIONS

This application is a continuation of International Application No. PCT/CN2024/140366, filed on Dec. 18, 2024, the disclosure of which is hereby incorporated by reference in its entirety.

### TECHNICAL FIELD

The present application relates to the field of communications technologies, and more specifically, to a wireless communication method, a terminal device, and a network device.

### BACKGROUND

In order to lower power consumption of a terminal device, a communications system introduces a low-power receiver. When the terminal device is idle, a main receiver may be turned off or set to a deep sleep state, and a first signal and/or a second signal are/is monitored only by using the low-power receiver. However, how to design the first signal and/or the second signal is an urgent problem to be resolved.

### SUMMARY

The present application provides a wireless communication method, a terminal device, and a network device. Various aspects involved in the present application are described below.

According to a first aspect, a wireless communication method is provided. The method includes: receiving, by a terminal device, one or more of the following transmitted by a network device: a first signal and a second signal, where the second signal is received based on the first signal; or the second signal, where the first signal and/or the second signal are/is obtained by overlaying a first sequence and/or a second sequence on orthogonal frequency division multiplexing (orthogonal frequency division multiplexing, OFDM) in time domain or frequency domain, the first signal and/or the second signal are/is received by a first receiver of the terminal device, and power consumption of the first receiver is less than power consumption of a second receiver of the terminal device.

According to a second aspect, a wireless communication method is provided. The method includes: transmitting, by a network device, one or more of the following to a terminal device: a first signal and a second signal, where the second signal is received based on the first signal; or the second signal, where the first signal and/or the second signal are/is obtained by overlaying a first sequence and/or a second sequence on orthogonal frequency division multiplexing OFDM in time domain or frequency domain, the first signal and/or the second signal are/is received by a first receiver of the terminal device, and power consumption of the first receiver is less than power consumption of a second receiver of the terminal device.

According to a third aspect, a terminal device is provided. The terminal device includes: a receiving unit, receiving one or more of the following transmitted by a network device: a first signal and a second signal, where the second signal is received based on the first signal; or the second signal, where the first signal and/or the second signal are/is obtained by overlaying a first sequence and/or a second sequence on orthogonal frequency division multiplexing OFDM in time domain or frequency domain, the first signal and/or the second signal are/is received by a first receiver of the terminal device, and power consumption of the first receiver is less than power consumption of a second receiver of the terminal device.

According to a fourth aspect, a network device is provided. The network device includes: a transmitting unit, transmitting one or more of the following to a terminal device: a first signal and a second signal, where the second signal is received based on the first signal; or the second signal, where the first signal and/or the second signal are/is obtained by overlaying a first sequence and/or a second sequence on orthogonal frequency division multiplexing OFDM in time domain or frequency domain, the first signal and/or the second signal are/is received by a first receiver of the terminal device, and power consumption of the first receiver is less than power consumption of a second receiver of the terminal device.

According to a fifth aspect, a terminal device is provided, including a processor, a memory, and a communications interface. The memory is configured to store one or more computer programs, and the processor is configured to invoke the computer program in the memory, to cause the terminal device to perform a part or all of the steps in the method in the first aspect.

According to a sixth aspect, a network device is provided, including a processor, a memory, and a transceiver. The memory is configured to store one or more computer programs, and the processor is configured to invoke the computer program in the memory, to cause the network device to perform a part or all of the steps in the method in the second aspect.

According to a seventh aspect, an embodiment of the present application provides a communications system. The system includes the foregoing terminal device and/or the foregoing network device. In another possible design, the system may further include another device that interacts with the terminal device or the network device in the solutions provided in embodiments of the present application.

According to an eighth aspect, an embodiment of the present application provides a computer-readable storage medium. The computer-readable storage medium stores a computer program. The computer program causes a communications device (for example, a terminal device or a network device) to perform a part or all of the steps in the method in the foregoing aspects.

According to a ninth aspect, an embodiment of the present application provides a computer program product. The computer program product includes a non-transitory computer-readable storage medium that stores a computer program. The computer program is operable to cause a communications device (for example, a terminal device or a network device) to perform a part or all of the steps in the method in the foregoing aspects. In some implementations, the computer program product may be a software installation package.

According to a tenth aspect, an embodiment of the present application provides a chip. The chip includes a memory and a processor, and the processor may invoke and run a computer program from the memory, to implement a part or all of the steps in the method in the foregoing aspects.

Embodiments of the present application propose a wireless communication method, where a first signal and/or a second signal received by a first receiver of a terminal device are/is obtained by overlaying a first sequence and/or a second sequence on OFDM in time domain or frequency domain, and power consumption of the first receiver is less than power consumption of a second receiver of the terminal device. The first signal and/or the second signal are/is obtained by overlaying the first sequence and/or the second sequence on OFDM, so as to implement uniform distribution of symbol energy of the first signal and/or the second signal in time domain, and help improve robustness of the first signal and/or the second signal to timing and frequency deviations.

### BRIEF DESCRIPTION OF THE DRAWINGS

FIG. 1 shows a wireless communications system 100 to which an embodiment of the present application is applied.

FIG. 2 is a schematic flowchart of a wireless communication method according to an embodiment of the present application.

FIG. 3 is a schematic diagram of a generation process of a low-power wake-up signal (low-power wake-up signal, LP-WUS).

FIG. 4 is an example diagram of an OFDM symbol used for transmitting a second signal.

FIG. 5 is an example diagram of a structure of an OFDM symbol used for transmitting a second signal.

FIG. 6 is a schematic structural diagram of a first signal.

FIG. 7 is a schematic diagram of a terminal device according to an embodiment of the present application.

FIG. 8 is a schematic diagram of a network device according to an embodiment of the present application.

FIG. 9 is a schematic structural diagram of a communications apparatus according to an embodiment of the present application.

### DETAILED DESCRIPTION OF THE EMBODIMENTS

The technical solutions in the present application are described below with reference to the accompanying drawings.

FIG. 1 shows a wireless communications system 100 to which an embodiment of the present application is applied. The wireless communications system 100 may include a network device 110 and terminal devices 120. The network device 110 may be a device that communicates with the terminal device 120. The network device 110 may provide communication coverage for a specific geographic area, and may communicate with the terminal device 120 located within the coverage.

FIG. 1 schematically shows one network device and two terminals. Optionally, the wireless communications system 100 may include a plurality of network devices, and another quantity of terminal devices may be included within coverage of each network device. This is not limited in embodiments of the present application.

Optionally, the wireless communications system 100 may further include other network entities such as a network controller and a mobility management entity. This is not limited in embodiments of the present application.

It should be understood that the technical solutions of embodiments of the present application may be applied to various communications systems, such as a 5th generation (5th generation, 5G) system or a new radio (new radio, NR) system, a long-term evolution (long term evolution, LTE) system, an LTE frequency division duplexing (frequency division duplex, FDD) system, and an LTE time division duplexing (time division duplex, TDD) system. The technical solutions provided in the present application may further be applied to a future communications system, such as a 6th generation mobile communications system or a satellite communications system.

The terminal device in embodiments of the present application may also be referred to as a user equipment (user equipment, UE), an access terminal, a subscriber unit, a subscriber station, a mobile site, a mobile station (mobile station, MS), a mobile terminal (mobile terminal, MT), a remote station, a remote terminal, a mobile device, a user terminal, a terminal, a wireless communications device, a user agent, or a user apparatus. The terminal device in embodiments of the present application may be a device providing a user with voice and/or data connectivity and capable of connecting people, objects, and machines, such as a handheld device or a vehicle-mounted device having a wireless connection function. The terminal device in embodiments of the present application may be a mobile phone (mobile phone), a tablet computer (Pad), a notebook computer, a palmtop computer, a mobile Internet device (mobile internet device, MID), a wearable device, a virtual reality (virtual reality, VR) device, an augmented reality (augmented reality, AR) device, a wireless terminal in industrial control (industrial control), a wireless terminal in self driving (self driving), a wireless terminal in remote medical surgery (remote medical surgery), a wireless terminal in a smart grid (smart grid), a wireless terminal in transportation safety (transportation safety), a wireless terminal in a smart city (smart city), a wireless terminal in a smart home (smart home), or the like. Optionally, the UE may be configured to function as a base station. For example, the UE may function as a scheduling entity, which provides a sidelink signal between UEs in V2X, D2D, or the like. For example, a cellular phone and a vehicle communicate with each other by using a sidelink signal. A cellular phone and a smart home device communicate with each other, without relay of a communication signal through a base station.

The network device in the embodiments of the present application may be a device for communicating with the terminal device. The network device may also be referred to as an access network device or a wireless access network device. For example, the network device may be a base station. The network device in embodiments of the present application may be a radio access network (radio access network, RAN) node (or device) that connects the terminal device to a wireless network. The base station may broadly cover devices having the following various names, or may be interchanged with the devices having following names, such as a NodeB (NodeB), an evolved NodeB (evolved NodeB, eNB), a next generation NodeB (next generation NodeB, gNB), a relay station, an access point, a transmitting and receiving point (transmitting and receiving point, TRP), a transmitting point (transmitting point, TP), a master eNodeB MeNB, a secondary eNodeB SeNB, a multi-standard radio (MSR) node, a home base station, a network controller, an access node, a radio node, an access point (access point, AP), a transmission node, a transceiver node, a baseband unit (base band unit, BBU), a remote radio unit (remote radio unit, RRU), an active antenna unit (active antenna unit, AAU), a remote radio head (remote radio head, RRH), a central unit (central unit, CU), a distributed unit (distributed unit, DU), and a positioning node. The base station may be a macro base station, a micro base station, a relay node, a donor node, or the like, or a combination thereof. Alternatively, the base station may be a communications module, a modem, or a chip disposed in the device or the apparatus described above. Alternatively, the base station may be a mobile switching center, a device that functions as a base station in device-to-device D2D, vehicle-to-everything (vehicle-to-everything, V2X), and machine-to-machine (machine-to-machine, M2M) communication, a network-side device in a 6G network, a device that functions as a base station in a future communications system, or the like. The base station may support networks of a same access technology or different access technologies. A specific technology and a specific device used by the network device are not limited in embodiments of the present application.

The base station may be a fixed or mobile base station. For example, a helicopter or an unmanned aerial vehicle may be configured to function as a mobile base station, and one or more cells may move according to a position of the mobile base station. In other examples, a helicopter or an unmanned aerial vehicle may be configured to function as a device in communication with another base station.

In some deployments, the network device in embodiments of the present application may be a CU or a DU, or the network device includes a CU and a DU. The gNB may further include an AAU.

The network device and the terminal device may be deployed on land, including being indoors or outdoors, handheld, or vehicle-mounted, may be deployed on a water surface, or may be deployed on a plane, a balloon, or a satellite in the air. In embodiments of the present application, a scenario of the network device and the terminal device is not limited.

It should be understood that all or a part of functions of the communications device in the present application may also be implemented by software functions running on hardware, or by virtualization functions instantiated on a platform (for example, a cloud platform).

In a cellular network, the terminal device (for example, a terminal device in a 5G network) usually consumes tens of milliwatts even if no data is transmitted or received. Power consumption of the terminal device in an idle state is caused because the terminal device must perform periodic measurement and check a potential paging message. Therefore, it is difficult to implement an Internet of things device in practice without support of an external power supply.

To address the foregoing problem, a communications system (for example, NR) introduces a low-power receiver. When the terminal device is idle, a main receiver may be turned off or set to a deep sleep state, and a first signal and/or a second signal are/is monitored only by using the low-power receiver, thereby reducing the power consumption of the terminal device. However, how to design the first signal and/or the second signal is an urgent problem to be resolved.

For example, the second signal is an LP-WUS. When the main receiver of the terminal device is woken up, the terminal device enters a radio resource control (radio resource control, RRC) connected state (CONNECTED). The low-power receiver of the terminal device may be continuously enabled to receive the LP-WUS. Therefore, the low-power receiver is independent of the main receiver, that is, the main receiver can be disabled when the low-power receiver is in an active state and searches for a potential LP-WUS. Because an instant at which the terminal device monitors an LP-WUS may be within a time period when a reduced-power physical downlink control channel (physical downlink control channel, PDCCH) is monitored, there may be a false wake-up when a plurality of terminal devices simultaneously monitor LP-WUSs. Therefore, how to embed an LP-WUS into a current communications system to ensure low-power performance of the terminal is an urgent problem to be resolved.

For another example, the first signal is a low power synchronization signal (low power synchronization signal, LP-SS). In a system based on a low-power wake-up signal, time and frequency synchronization processes are also very important. When the main receiver is configured with a long “off mode” or a sleep period, a clock rate of the terminal device may drift. A clock rate drift or frequency error may cause a duty cycle of a low power wake up receiver (low power wake up receiver, LP-WUR) to be inaccurate. Therefore, the low-power receiver of the terminal device can be configured to detect and receive periodic LP-SSs to achieve accurate synchronization at the low-power receiver and wake up the main receiver by using an LP-WUS. Therefore, how to design an LP-SS is also a technical problem that needs to be resolved.

In view of the foregoing problems, embodiments of the present application propose a wireless communication method, where a first signal and/or a second signal received by a first receiver of a terminal device are/is obtained by overlaying a first sequence and/or a second sequence on OFDM in time domain or frequency domain, and power consumption of the first receiver is less than power consumption of a second receiver of the terminal device. The first signal and/or the second signal are/is obtained by overlaying the first sequence and/or the second sequence on OFDM, so as to implement uniform distribution of symbol energy of the first signal and/or the second signal in time domain, and help improve robustness of the first signal and/or the second signal to timing and frequency deviations.

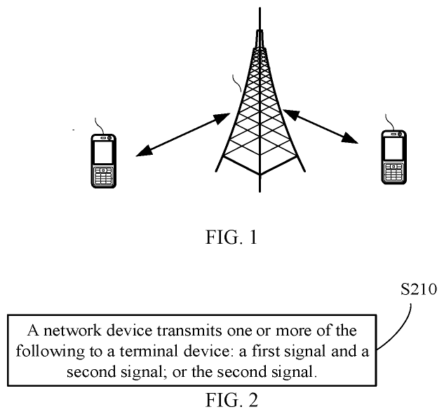

The following describes the wireless communication method according to this embodiment of the present application with reference to FIG. 2. FIG. 2 is a schematic flowchart of a wireless communication method according to an embodiment of the present application. The solution shown in FIG. 2 includes Step S210.

In Step S210, a network device transmits one or more of the following to a terminal device: a first signal and a second signal; or the second signal. Correspondingly, the terminal device receives one or more of the following transmitted by the network device: the first signal and the second signal; or the second signal.

In some implementations, the terminal device includes a first receiver and a second receiver, power consumption of the first receiver is less than power consumption of the second receiver. A first signal and/or a second signal are/is received by the first receiver of the terminal device, or in other words, the first signal and/or the second signal are/is monitored by the terminal device by using the first receiver.

In some implementations, the power consumption of the first receiver is less than the power consumption of the second receiver. Therefore, the first receiver may be the low-power receiver (low-power receiver, LR) described above, and the second receiver may be the main receiver (main receiver, MR) described above.

In some implementations, the first signal and/or the second signal are/is received by the LR, and the first signal and/or the second signal may also be referred to as a “low-power signal”.

In some implementations, the first receiver may also be referred to as a low-power wake-up module or an LP-WUR, and the second receiver may also be referred to as a “main communications module”.

In some implementations, the foregoing may be two separate receiving modules, or may be integrated into one receiving module, that is, the first receiver and the second receiver are two separate modules, or the first receiver and the second receiver are integrated into one module.

In some implementations, the terminal device receives the first signal and the second signal transmitted by the network device, and the second signal is received based on the first signal. That is, after receiving the first signal transmitted by the network device, the terminal device receives the second signal transmitted by the network device based on the received first signal.

In some implementations, the first signal is a signal used for time and frequency synchronization. Correspondingly, the terminal device performs synchronization based on the received first signal.

In some implementations, the second signal is a signal used for waking up the second receiver.

In some implementations, the first signal is the LP-SS described above. The LP-SS is periodic signaling used by the LP-WUR to achieve and maintain time and frequency synchronization.

In some implementations, the second signal is the LP-WUS described above. For example, the first signal is an LP-SS, and the second signal is an LP-WUS. The LP-WUR of the terminal device may first receive the LP-SS, and use the LP-SS for time and frequency synchronization, or may use the LP-SS for radio resource management (radio resource management, RRM) measurement to determine potential coverage and detectability of further LP-WUS reception and detection.

In some implementations, the first signal is an LP-SS signal, and the LP-SS signal supports a periodicity of one or more of the following: 80 ms, 160 ms, 320 ms, 640 ms, 1280 ms, 2560 ms, 5120 ms, or 10240 ms.

In some implementations, a modulation scheme of the first signal and/or a modulation scheme of the second signal may be a low-rate modulation scheme, that is, the modulation scheme of the first signal and/or the modulation scheme of the second signal may be a modulation scheme that can modulate the first signal and/or the second signal into a low-rate signal.

In some implementations, the low-rate modulation scheme may be one or more of the following: on-off keying (on-off keying, OOK); pulse modulation; or modulation based on a specific function.

In some implementations, a modulation scheme of the first signal and/or a modulation scheme of the second signal are/is OOK. For example, the second signal is an LP-WUS, and an information bit of LP-WUS may be carried by a modulated OOK sequence or OOK bits.

In some implementations, a modulation scheme of the first signal and/or a modulation scheme of the second signal are/is OOK, and the first sequence and/or the second sequence corresponding to the first signal and/or the second signal modulated based on OOK modulation may be a complex-valued sequence. For example, a signal sequence of the first signal modulated based on OOK modulation is an OOK sequence. An OFF symbol in the OOK sequence may be mapped to an all-zero sequence, and an ON symbol in the OOK sequence may be mapped to the first sequence. The first sequence is a specific short complex-valued sequence. These sequences are connected to obtain a pre-discrete Fourier transform (discrete fourier transform, DFT) sequence.

In some implementations, if the modulation scheme of the first signal and/or the modulation scheme of the second signal are/is OOK, the first receiver may detect the first signal and/or the second signal through correlation.

In some implementations, the modulation scheme of the first signal and the modulation scheme of the second signal are both OOK. Because the LP-WUR may detect the first signal and the second signal at the same time, OOK configurations of the first signal and the second signal may be the same, so that detection of the LP-WUR is simpler.

In some implementations, a coding scheme of the first signal and/or a coding scheme of the second signal include/includes one or more of the following: non-return-to-zero inverted encoding; Manchester coding; unipolar return-to-zero encoding; differential binary phase encoding; Miller encoding; modified Miller encoding; pulse interval encoding; pulse position encoding; bi-phase space encoding; or pulse width encoding.

In some implementations, a cyclic redundancy check (cyclic redundancy check, CRC) may be added after the first signal and/or the second signal are/is encoded.

In some implementations, the first signal and/or the second signal are/is generated from the first sequence and/or the second sequence. In other words, the first signal is generated from the first sequence, and/or the second signal is generated from the second sequence.

In some implementations, that the first signal and/or the second signal are/is generated from the first sequence and/or the second sequence may be understood as that the first signal and/or the second signal are/is obtained by overlaying the first sequence and/or the second sequence on OFDM, that is, the first signal is obtained by overlaying the first sequence on OFDM, and the second signal is obtained by overlaying the second sequence on OFDM.

In this embodiment of the present application, there is no limitation on an occasion of overlaying the first sequence and/or the second sequence on OFDM. For example, the first sequence may be overlaid on OFDM before encoding, or the first sequence may be overlaid on OFDM after encoding. For another example, the first sequence is overlaid on OFDM in time domain, or the first sequence is overlaid on OFDM in frequency domain.

In some implementations, the first signal and/or the second signal are/is obtained by overlaying the first sequence and/or the second sequence on OFDM in time domain, and the first sequence and/or the second sequence are/is time domain sequences.

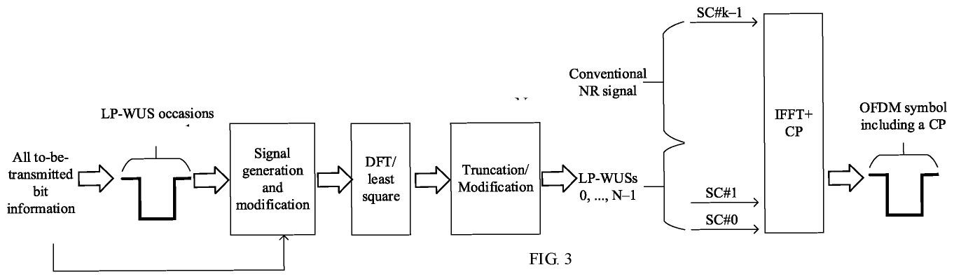

In some implementations, that the first signal and/or the second signal are/is obtained by overlaying the first sequence and/or the second sequence on OFDM in time domain may be understood as that the first sequence and/or the second sequence are/is overlaid on OFDM before DFT/LS, that is, the first sequence and/or the second sequence in time domain are/is overlaid on OFDM, and then, DFT/LS and IFFT are performed to obtain the first signal and/or the second signal. For example, the second signal is an LP-WUS. Referring to FIG. 3, FIG. 3 is a schematic diagram of a generation process of an LP-WUS. Based on occasions of N′ LP-WUSs, the LP-WUSs are modulated using an OOK-4 modulation scheme, and OOK ON symbols of the modulated LP-WUSs correspond to the second sequence. The second sequence may be overlaid on OFDM before DFT/least square (least square, LS) (such as in a signal generation and modification stage).

In some implementations, the first signal and/or the second signal are/is obtained by overlaying the first sequence and/or the second sequence on OFDM in frequency domain, and the first sequence and/or the second sequence are/is frequency domain sequences.

In other implementations, that the first signal and/or the second signal are/is obtained by overlaying the first sequence and/or the second sequence on OFDM in frequency domain may be understood as that the first sequence and/or the second sequence are/is overlaid on OFDM before IFFT, and the overlaid first sequence and/or second sequence are/is frequency domain sequences. That is, the first sequence and/or the second sequence can be overlaid on OFDM in frequency domain to obtain the first signal and/or the second signal. For example, the second signal is an LP-WUS. Referring to FIG. 3, FIG. 3 is a schematic diagram of a generation process of an LP-WUS. Based on occasions of N′ LP-WUSs, the LP-WUSs are modulated using an OOK-4 modulation scheme, and OOK ON symbols of the modulated LP-WUSs correspond to the second sequence. The second sequence is overlaid on OFDM before inverse fast Fourier transform (inverse fast fourier transform, IFFT) (for example, in a sub-carrier (sub-carrier, SC) overlaying stage).

In some implementations, if the first signal is an LP-SS, timing information of the first signal is determined based on timing information of the third signal. For example, a time resource occupied by the third signal may be used by the terminal device to determine the timing information of the first signal, and the timing information may be frame/subframe/slot/symbol timing information.

In some implementations, the third signal includes one or more of the following: a synchronization signal/physical broadcast channel block (synchronization signal/PBCH block, SSB); an SSB burst set; or a primary synchronization signal (primary synchronization signal, PSS)/secondary synchronization signal (secondary synchronization signal, SSS) in an SSB.

In some implementations, that a time resource occupied by the first signal overlaps with a time resource occupied by the third signal may be understood as that the first signal and the third signal are multiplexed in a same OFDM symbol. Therefore, the first signal and the third signal can share the same timing information. For example, the first signal is an LP-SS, the third signal includes an SSB, the LP-SS and the SSB are multiplexed in a same OFDM symbol, and the terminal device detects the LP-SS and may determine timing information based on an SSB configuration.

In some implementations, the time resource occupied by the first signal may partially overlap or completely overlap with the time resource occupied by the third signal.

In some implementations, in order to achieve frequency domain multiplexing (frequency domain multiplexing, FDM) with the SSB, the same number of OFDM symbols may be supported for transmitting the LP-SS and the SSB.

In some implementations, the first signal and the third signal have a quasi co-location (quasi co-location, QCL) relationship. For example, the third signal includes an SSB burst set, the first signal is an LP-SS, the LP-SS is transmitted based on a beam, an LP-SS set is defined, and the set includes a plurality of LP-SSs (LP-SS #1, LP-SS #2, LP-SS #3, . . . , and LP-SS #M-1). Indexes of LP-SSs in the LP-SS set are 0, 1, . . . , and M−1, and M may be equal to or less than a number of SSBs in an SSB burst. It is assumed that an LP-SS and an SSB having a same index are QCLed, and a QCL relationship between the LP-SS and the SSB may be determined based on the index of the LP-SS in the LP-SS set. The network device may naturally transmit the LP-SS and the SSB by using a same transmitter (transmitter, TX) beam. The terminal device may also determine an associated SSB based on a detected LP-SS, and then determine timing information of the SSB.

In some implementations, an information bit of the second signal is carried in overlaid OFDM. In other words, the information bit of the second signal is carried in an overlaid OFDM symbol. For example, the second signal is an LP-WUS, the modulation scheme of the second signal is OOK, and a single second sequence is located on each OOK ON symbol or OFDM symbol duration. The OFDM-based LP-WUR may obtain an entire information bit of the LP-WUS through overlaid OFDM. In this scheme, the overlaid sequence used can be randomized over time, which may reduce impact of interference between cells and therefore achieve better coverage performance. The second sequence may be predetermined from a plurality of sequences, for example, determined from a plurality of candidate sequences. That is, one sequence is selected for each OOK ON symbol, the OFDM-based LP-WUR obtains the information bit of the LP-WUS at least through overlaid OFDM, and overlaid OFDM carries all of the information bit of the LP-WUS.

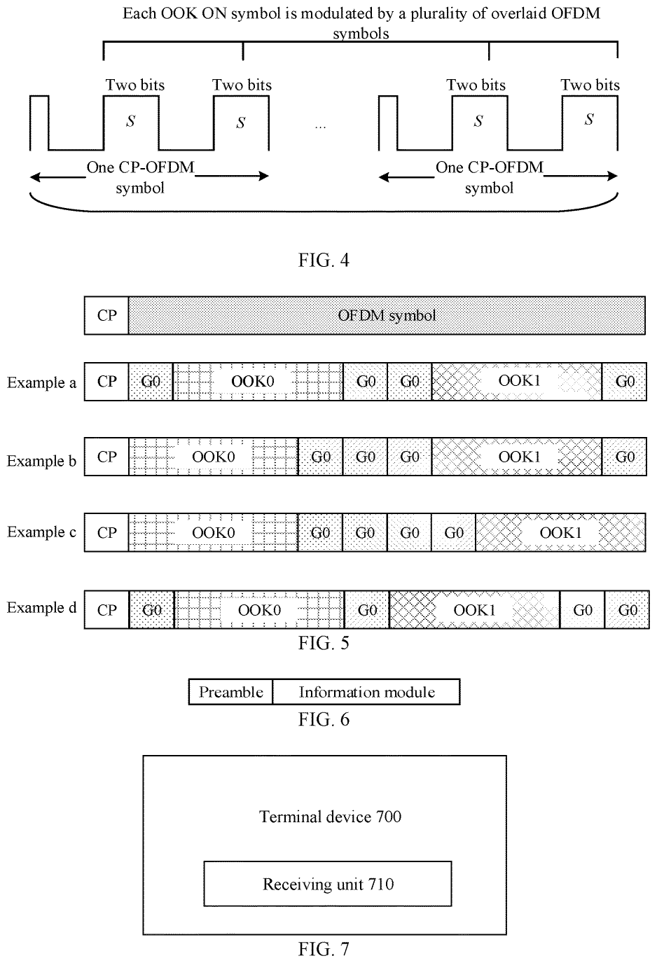

For ease of understanding, the following describes, with reference to FIG. 4, an example of a solution in which overlaid OFDM carries the information bit of the second signal.

Refer to FIG. 4. It is assumed that the second signal is an LP-WUS, an S-sequence is the second sequence, and the S-sequence may be one sequence selected from a plurality of candidate sequences, for example, from S(n). In each OFDM symbol, four bits may be carried by OFDM on two OOK ON symbols, where it is assumed that there are N information bits. The LP-WUS supports OOK-4 modulation and has a coding scheme that is Manchester coding. Since the information bits are mapped to overlaid OFDM, in this case, the OFDM-based receiver can obtain information only from overlaid OFDM. OOK-4 is used as an example, and one LP-WUS carries N information bits and occupies N/4 OFDM symbols. If entire information of one LP-WUS includes 24 bits, a total of N/4=6 OFDM symbols are occupied without repetition. Alternatively, the S-sequence may be a specific sequence, and only one candidate second sequence can be transmitted on each OOK ON symbol. For specific candidate second sequences, a same sequence may be fixedly mapped to each OOK ON symbol, or a different second sequence may be mapped to each OOK ON symbol according to a predetermined rule. Both an envelope detection-based receiver and the OFDM-based receiver can detect the LP-WUS. All the N information bits of the LP-WUS are carried/modulated on each OFDM symbol by an OOK ON/OFF pattern.

In some implementations, the information bit of the second signal is associated with one or more of the following: information content carried in the second signal; a code rate of the second signal; a number of paging occasions (paging occasion, PO) of the second signal; a number of terminal devices indicated by the POs of the second signal; or a number of times the second signal is monitored.

In some implementations, the information content carried in the second signal may be understood as information content carried in the second signal and used for waking up the second receiver. Therefore, the information content carried in the second signal may also be referred to as “wake-up information”. For example, the second signal is an LP-WUS, and the information content carried in the LP-WUS may be wake-up information used for waking up a second receiver of a specific terminal device.

In some implementations, the code rate of the second signal may be understood as a proportion of a useful part (non-redundant) in a data stream of the encoded second signal. For example, the second signal is an LP-WUS, the modulation scheme of the LP-WUS is OOK, the coding scheme of the LP-WUS is Manchester coding, and a proportion of OOK ON symbols after modulation and encoding of the LP-WUS is the code rate of the second signal.

In some implementations, the number of POs of the second signal may be understood as a number of POs or a number of PO subgroups of the second signal.

In some implementations, the number of terminal devices indicated by the POs of the second signal may be understood as a number of terminal devices indicated by the POs of the second signal, or a number of terminal device groups indicated by PO subgroups.

In some implementations, the number of times the second signal is monitored may be understood as a number of times the terminal device can monitor the second signal.

In some implementations, the number of times the second signal is monitored is associated with a number of low-power occasions (low-power occasion, LO) and/or a number of monitoring occasions (monitoring occasion, MO) of the second signal. For example, the second signal is an LP-WUS, and the LO may be understood as an opportunity for low-power signal transmission. Due to characteristics of an LP-WUR system, spectral efficiency of the LP-WUS is much less than that of a PDCCH. In this case, a plurality of monitoring occasions (that is, MO) for the wake-up signal may be configured for different LOs associated with different subgroups of terminal devices. A paging early indication (paging early indication, PEI) and/or a PO are/is associated with a MO, instead of associating a PO with a LO. Each LP-WUS has one LO, or one LP-WUS can have a plurality of LOs. It is also possible that the LP-WUR system has only a LO but no MO, or has only a MO but no LO. Alternatively, both a MO and a LO are configured. The number of times the LP-WUS is monitored may be associated with a number of LOs and a number of MOs, or a number of LOs, or a number of MOs in LOs.

In some implementations, if the second sequence is overlaid on OFDM before encoding, a size of the information bit of the second signal is associated with the information content carried in the second signal. For example, the second signal is an LP-WUS, and the modulation scheme of the LP-WUS is OOK. A number of OOK ON symbols of the modulated LP-WUS depends on the information content carried in the LP-WUS. Therefore, a size of an information bit obtained by overlaying the second sequence that is mapped to an OOK ON symbol on OFDM is also related to the information content carried in the LP-WUS. A larger number of OOK-ON symbols for the LP-WUS indicates a larger number of overlaid OFDM transmission occasions (one OOK-ON symbol may be considered as one OFDM transmission occasion). The wake-up information carried in the LP-WUS may affect coverage of OFDM. If the modulated LP-WUS does not have an OOK ON symbol (for example, the modulated LP-WUS is 0000), OFDM cannot be overlaid on the second sequence.

In some implementations, if the second sequence is overlaid on OFDM after encoding, a size of the information bit of the second signal is associated with the information content carried in the second signal and/or the code rate of the second signal.

In some implementations, the size of the information bit of the second signal is associated with POs indicated by information carried in the second signal and/or the number of terminal devices indicated by the POs of the second signal. For example, a maximum value of the size of the information bit of the second signal is associated with a maximum number of POs or a maximum number of PO subgroups of the second signal.

In some implementations, for a terminal device in an RRC idle (RRC_IDLE) mode/RRC inactive (RRC_INACTIVE) mode, the size of the information bit of the second signal is associated with the number of terminal devices indicated by the POs of the second signal and/or the number of times the second signal is monitored. For example, the second signal is an LP-WUS, and the number of terminal devices indicated by the POs of the LP-WUS and a number of MOs in LOs of the LP-WUS may determine the size of the information bit of the LP-WUS.

In some implementations, the size of the information bit of the second signal is associated with the number of PO subgroups of the second signal. For example, the second signal is an LP-WUS, the modulation scheme of the LP-WUS is OOK, and the size of the information bit of the LP-WUS obtained by overlaying a second sequence that is mapped to a respective OOK ON symbol on OFDM is at least a maximum number of PO subgroups, such as 8, 16, 32, or 64.

In some implementations, the size of the information bit of the second signal is further associated with one or more of the following: network configuration information; a number of cells in a tracking area; density of terminal devices in a cell; or a current traffic volume. For example, the second signal is an LP-WUS, and the size of the information bit of the LP-WUS may depend on the number of cells in the tracking area, density of terminal devices in a cell, the current arriving traffic volume, and the like.

In some implementations, the first sequence and the second sequence have a first association relationship.

In some implementations, the first association relationship is used to indicate one or more of the following: the first sequence being the same as the second sequence; the first sequence being different from the second sequence; a modulation order of the first sequence being the same as a modulation order of the second sequence; a modulation order of the first sequence being different from a modulation order of the second sequence; or a modulation order of the first sequence being greater than or equal to a modulation order of the second sequence.

In some implementations, the first sequence is the same as the second sequence, that is, the first signal and the second signal may be generated from a same sequence.

In some implementations, the first sequence is different from the second sequence, that is, the first signal and the second signal may be generated from different sequences.

In some implementations, the modulation order of the first sequence may be the same as the modulation order of the second sequence. For example, if the first signal is an LP-SS and the second signal is an LP-WUS, and the modulation scheme of the LP-WUS and the modulation scheme of the LP-SS are both OOK, the modulation order M₁ of the first sequence corresponding to the LP-SS is always the same as the modulation order M₂ of the second sequence corresponding to the LP-WUS.

In some implementations, the modulation order of the first sequence may be different from the modulation order of the second sequence. For example, if the first signal is an LP-SS and the second signal is an LP-WUS, and the modulation scheme of the LP-WUS and the modulation scheme of the LP-SS are both OOK, the modulation order M₁ of the first sequence corresponding to the LP-SS is different from the modulation order M₂ of the second sequence corresponding to the LP-WUS.

In some implementations, the modulation order of the first sequence is greater than or equal to the modulation order of the second sequence. In other words, the modulation order of the second sequence cannot be greater than the modulation order of the first sequence. For example, if the first signal is an LP-SS and the second signal is an LP-WUS, and the modulation scheme of the LP-WUS and the modulation scheme of the LP-SS are both OOK, the modulation order M₁ of the first sequence corresponding to the LP-SS and the modulation order M₂ of the second sequence corresponding to the LP-WUS meet M₁≥M₂.

In some implementations, the modulation scheme of the first signal and/or the modulation scheme of the second signal are/is OOK, and a data transmission rate of the first signal and/or a data transmission rate of the second signal may be adjusted by adjusting the modulation orders and/or a subcarrier spacing (subcarrier spacing, SCS). For example, when the modulation order of OOK is 1, for OOK-1, each OFDM symbol can be used for transmitting only one OOK symbol. If different data transmission rates need to be supported, this can be implemented by adjusting the SCS. For another example, when the modulation order of OOK is M, for OOK-M, each OFDM symbol can be used for transmitting M OOK symbols, and different data transmission rates can be supported by adjusting the value of M and/or the value of the SCS.

In some implementations, the data transmission rate of the first signal and/or the data transmission rate of the second signal may be determined based on channel quality. For example, the second signal is an LP-WUS. In actual transmission of the LP-WUS, performance of the LP-WUS varies due to different channel quality. When the channel quality is good, a higher data transmission rate may be used to transmit the LP-WUS. When the channel quality is poor, a lower data transmission rate may be used to transmit the LP-WUS.

In some implementations, the first sequence and/or the second sequence are/is determined based on one or more of the following: a preconfigured sequence; a predefined sequence; or one or more candidate sequences.

In some implementations, the preconfigured sequence may be understood as a sequence configured by the network device.

In some implementations, the predefined sequence may be understood as a sequence defined by a protocol.

In some implementations, the one or more candidate sequences may be understood as one or more candidate first sequences and/or one or more candidate second sequences.

In some implementations, the candidate sequence is generated based on a basic sequence.

In some implementations, the basic sequence may be one or more of the following: a ZC sequence, a Gold sequence, an M-sequence, or a computer search sequence.

In some implementations, that the candidate sequence is generated based on a basic sequence may be understood as that the candidate sequence is obtained by performing at least one of the following operations on a basic sequence: cyclic shift; extension; or truncation.

In some implementations, the candidate sequence is obtained by performing a cyclic shift operation on the basic sequence. This may be understood as that the candidate sequence is obtained by cyclically shifting the basic sequence. The cyclic shift is an operation that changes positions of elements in a sequence without changing a generation mechanism of the sequence. The cyclic shift may be implemented in hardware by using a shift register, thereby avoiding additional complex calculation.

In some implementations, the cyclic shift operation may include a cyclic left shift and/or a cyclic right shift.

In some implementations, a plurality of candidate sequences having different characteristics may be generated by changing a step size of the cyclic shift of the basic sequence. By selecting different step sizes of the cyclic shift, it is possible to reduce a cross-correlation peak between sequences.

In some implementations, the cyclic shift includes one or more step sizes.

In some implementations, the candidate sequence is obtained by performing an extension operation on the basic sequence. This may be understood that the candidate sequence is obtained by increasing a number of bits of the basic sequence.

In some implementations, the extension operation includes one or more of the following: cyclic extension; binary complement; or decimation.

In some implementations, the candidate sequence is obtained by performing a truncation operation on the basic sequence. This may be understood as that the candidate sequence is obtained by truncating the basic sequence to a specific length.

In some implementations, the candidate sequence is obtained by padding zeros before and/or after the extension of the basic sequence, and a total number of zeros is determined by formula N₀=L−N, where L is a length of the candidate sequence, and N is a length of the basic sequence. For example, the basic sequence is a ZC sequence X_{q}, and may be expressed by formula form

$${x}_{q} ( m ) = {e}^{- j \frac{π q m ( m + 1 )}{{N}_{ZC}}}$$

for m=0,1, . . . , N_{ZC}−1, where q is a root sequence, N_{ZC} is a length of each sequence, zeros are added to X_{q} before extension, to obtain a sequence s(n)=[0,0 . . . , X_{q}(0), . . . . X_{q}(N_{ZC}−1), 0,0 . . . 0] for n=0,1, . . . , L_{ZC}−1, that is, zero padding is performed before and after X_{q}, a total number of zeros is L_{ZC}−N_{ZC}, and L_{ZC} is a length of a final candidate sequence.

In some implementations, the basic sequence is a ZC sequence, and the candidate sequence is obtained by cyclically extending the ZC sequence. For example, the basic sequence is a ZC sequence, and may be expressed by formula form

$${x}_{q} ( m ) = {e}^{- j \frac{π q m ( m + 1 )}{{N}_{ZC}}}$$

for m=0,1, . . . , N_{ZC}−1, where q is a root sequence, N_{ZC} is a length of each sequence, a value of N_{ZC} may be an odd number (or a prime number) such that N_{ZC} meets N_{ZC}<L_{ZC}−2×GO, L_{ZC} is a length of the candidate sequence, GO is a value set by the system, GO is related to a length of DFT/fast Fourier transform (fast fourier transform, FFT) and a result after modulation, and a value of GO is greater than or equal to 0. The candidate sequence may be obtained by formula S(n)=x_{q}(n mod N_{ZC}) or determined by formula

$$S ( n ) = {e}^{j α} {x}_{q} ( n mod {N}_{ZC} ) ,$$

where α is set by the system.

In some implementations, the basic sequence is a ZC sequence, and the candidate sequence is obtained by cyclically shifting and extending the ZC sequence. For example, the basic sequence is a ZC sequence, and may be expressed by formula

$${x}_{q} ( m ) = {e}^{- j \frac{π q m ( m + 1 )}{{N}_{ZC}}}$$

for m=0,1, . . . , N_{ZC}−1. The ZC sequence may be cyclically extended to obtain a sequence S(n)=x_{q}(n mod N_{ZC}) for n=0,1, . . . . L_{ZC}−1, and S(n) may be cyclically shifted to obtain S′(n)=x_{q}((n+Cv)mod N_{ZC}) for n=0,1, . . . . L_{ZC}−1, where C_{V} is a step size of the cyclic shift. Zero padding is performed on X_{q} to obtain a sequence s(n)=[0,0 . . . , X_{q}(0), . . . . X_{q}(N_{ZC}−1), 0,0 . . . 0] for n=0.1 . . . . L_{ZC}−1, that is, zero padding is performed before and after X_{q}, and a total number of zeros is L_{ZC}-N_{ZC}. Then, s(n) may be cyclically shifted and cyclically extended, to obtain a candidate sequence s′ (n)=[0,0 . . . , Y_{q}(0), . . . . Y_{q}(N_{ZC}−1), 0,0 . . . 0] for n=0.1 . . . . L_{ZC}−1, where Y_{q} (j)=x_{q}((j+C_{V}) mod N_{ZC})) for j=0,1, . . . . L_{ZC}−1.

In some implementations, the basic sequence is a ZC sequence, and the ZC sequence may include one or more root sequences. That is, the candidate sequence may be generated from ZC sequences based on one or more different root sequences.

To support a plurality of candidate sequences and also allow different cells to have different candidate sequences, in some implementations, different step sizes of cyclic shifts and different root sequences of ZC sequences may be used to generate a plurality of candidate sequences, or a same root sequence of ZC sequences and different step sizes of cyclic shifts may be used to generate a plurality of candidate sequences. Selection of a root sequence of a ZC sequence directly affects cross-correlation characteristics between different candidate sequences. Candidate sequences generated from different root sequences have relatively low cross-correlation, which helps reduce interference. Candidate sequences generated from a same root sequence but based on different cyclic shift step sizes are easy to distinguish at a receive end. Generating a candidate sequence using a combination of a step size of a cyclic shift and a root sequence of a ZC sequence is conducive to coping with different timing error cases.

For a plurality of supported candidate sequences, cyclic shifts should be evenly distributed throughout an entire period to prevent the cyclic shifts from being concentrated in specific positions to cause high cross-correlation. To cope with different timing error cases, in some implementations, a root sequence of a ZC sequence and/or a step size of a cyclic shift may be combined according to a first rule.

In some implementations, the first rule is used to indicate that different cyclic shift step sizes of a same root sequence are preferentially configured, which is conducive to providing good cross-correlation performance while saving spectrum resources.

In some implementations, the first rule is used to instruct to allocate different root sequences to adjacent cells to ensure low cross-correlation between candidate sequences corresponding to different cells, thereby reducing interference between cells.

In some implementations, the first rule indicates that an interval between indexes of root sequences is greater than a minimum interval that ensures low cross-correlation between different root sequences. For example, indexes q₁ and q₂ of two root sequences should be chosen to meet |q₁−q21>Δ_{q}, where Δ_{q} is a minimum interval that ensures low cross-correlation between different root sequences.

In some implementations, the root sequence of the ZC sequence and the step size of the cyclic shift may be configurable by the network device. For example, the network device is a gNB, and the gNB configures the root sequence of the ZC sequence and the step size of the cyclic shift that are to be used.

In some implementations, the root sequence of the ZC sequence and/or the step size of the cyclic shift are/is determined based on one or more of the following: a modulation order of the first signal and/or a modulation order of the second signal; a length of the basic sequence; network load information; channel state information; an inter-cell interference condition; or a timing error of the terminal device.

The cyclic shift may be configured to generate a plurality of orthogonal subsequences on a same root sequence. The step size of the cyclic shift should ensure that cross-correlation between different candidate sequences is minimized. In some implementations, the step size of the cyclic shift is determined based on the modulation order of the first signal and/or the modulation order of the second signal and the length of the basic sequence.

In some implementations, the basic sequence is a ZC sequence, and the step size of the cyclic shift meets

$${C}_{V} \geq \frac{{N}_{ZC}}{M} ,$$

where C_{V} is the step size of the cyclic shift, N_{ZC} is the length of the ZC sequence, and M is the modulation order of the first signal and/or the modulation order of the second signal.

In some implementations, the root sequence of the ZC sequence and the step size of the cyclic shift are determined based on the network load information and the channel state information. For example, in practical deployment, the gNB adjusts the root sequence and the step size of the cyclic shift based on real-time network load information and channel state information.

In some implementations, the root sequence of the ZC sequence is determined based on the inter-cell interference condition. For example, the gNB allocates different root sequences based on the inter-cell interference condition.

In some implementations, the step size of the cyclic shift of the ZC sequence is determined based on the timing error of the terminal device. For example, for a terminal device having a large timing error, the step size of the cyclic shift is adjusted to optimize receiving performance of the terminal device.

In some implementations, the basic sequence is a Gold sequence, and the candidate sequence is obtained by truncating the Gold sequence. For example, the candidate sequence is a sequence obtained by truncating a Gold sequence having a length of 127 or 231.

In some implementations, the basic sequence is an M-sequence. The M-sequence has good cross-correlation characteristics at a cost that a number of available sequences (a sequence shorter than the Gold sequence) is limited, and a length of consecutive “0s” in the M-sequence is limited.

In some implementations, the M-sequence is generated based on one or more generator polynomials. For example, according to system requirements, a suitable M-sequence generator polynomial is selected, and an M-sequence S=[s₀, s₁, s₂, . . . , S_{N-1}] is generated. A length of the M-sequence is N=2ⁿ−1, where n is a number of register levels. For example, if a generator polynomial x³+x+1 is selected, n=3, a length of a generated M-sequence is N=7, and the M-sequence is generated by a linear feedback shift register (linear feedback shift register, LFSR).

In some implementations, the basic sequence is an M-sequence, and the candidate sequence is obtained by cyclically shifting the M-sequence. For example, by performing different cyclic shift operations on the M-sequence, a plurality of low-complexity sequences having good autocorrelation and cross-correlation characteristics may be generated. This method can meet requirements of multi-user environments or different symbols while maintaining simple hardware implementation. For example, the initial M-sequence S=[s₀, s₁, s₂, . . . , s_{N-1}] is cyclically shifted, and the shifted sequence S(k) is expressed by: S(k)=[sₖ, sₖ+1, . . . , s_{N-1}, s₀, s₁, . . . , sₖ₋₁]. By selecting different values of k as the step size of the cyclic shift, such as k=N/4 or k=N/2, a set of candidate sequences having similar autocorrelation characteristics but relatively low cross-correlation may be generated. In applications of the first signal and/or the second signal, maintaining an approximate balance between a number of “0s” and a number of “1s” in a sequence can improve power balance and detection performance. Therefore, a shifted sequence also basically maintains this balance. The sequence generated by the cyclic shift operation maintains the number of “0s” and the number of “1s” in a balanced state. This characteristic ensures that an envelope of the first signal and/or an envelope of the second signal based on OOK modulation is also centered around an average value, which is beneficial to low-complexity envelope detection.

To obtain a relatively low cross-correlation peak, in some implementations, the step size of the cyclic shift of the M-sequence is determined based on the length of the M-sequence.

In some implementations, the step size of the cyclic shift of the M-sequence meets

$${C}_{V} ∈ [ \frac{{N}_{M}}{4} , \frac{3 {N}_{M}}{4} ] ,$$

the length of the M-sequence.

In some implementations, the step size of the cyclic shift of the M-sequence may be an equally spaced step size to ensure uniform distribution of the sequence.

In some implementations, the step size of the cyclic shift of the M-sequence may be a prime number. A prime step size may reduce repetitive patterns between sequences, and is conducive to reducing a cross-correlation peak.

In order to fully utilize a power of the network device, a power level in each OFDM symbol for transmitting the first signal and/or the second signal needs to be strictly kept the same. For design of the first sequence and/or the second sequence, in order to obtain a plurality of candidate sequences, in some implementations, the M-sequence may be generated based on step sizes of cyclic shifts of a plurality of M-sequences and/or a plurality of generator polynomials. In practical implementations, using a plurality of different cyclic shift step sizes may be preferred over different generator polynomials to obtain better correlation and limit the implementation to a single LFSR.

In some implementations, the basic sequence is an M-sequence, and the candidate sequence is obtained by extending or truncating the M-sequence. For example, the M-sequence is extended through cyclic extension, binary complement, decimation, or the like or is truncated to generate a candidate sequence.

In some implementations, the basic sequence is an M-sequence, and candidate sequences are different sequences generated by applying a cyclic shift to the M-sequence before or after extension/truncation and having different correlation characteristics.

In order to achieve timing synchronization with envelope detection, the first signal needs to have an envelope having good autocorrelation characteristics, so that an LR may find timing by obtaining peak positions through correlation operations. In some implementations, the first signal is an LP-SS, the modulation scheme of the LP-SS is OOK, and the first sequence corresponding to the LP-SS is generated based on the M-sequence. That is, the LP-SS may be modulated at an input end by using the OOK modulation scheme having good autocorrelation characteristics, and the first sequence generated based on the M-sequence is mapped to an OOK ON symbol.

In some implementations, a length of the first sequence and/or a length of the second sequence are/is associated with one or more of the following: a number of transmission resource blocks of the first signal and/or a number of transmission resource blocks of the second signal; a modulation order of the first signal and/or a modulation order of the second signal; a length of the basic sequence; a subcarrier spacing; channel state information; mobility of the terminal device; power consumption of the terminal device; or a detection requirement of the terminal device.

In some implementations, the length of the first sequence and/or the second sequence are/is associated with the modulation order of the first signal and/or the modulation order of the second signal. For example, the modulation scheme of the first signal may support OOK-1, OOK-4, . . . , and OOK-M. A modulation order of OOK-M is considered to be M=1, 2, or 4, or M=1, 2, 4, or 16, or other values. If the first signal supports OOK modulation having a plurality of different M values, the network device may be configured with a first sequence used for a serving cell and a plurality of first sequences used for non-serving cells. Different first sequences may have different OOK modulation having different M values. Therefore, for each value of M, one or more lengths of the first sequence may be supported.

In some implementations, that the length of the first sequence and/or the second sequence are/is associated with the modulation order of the first signal and/or the modulation order of the second signal may be understood as that a value range of the length of the first sequence and/or a value range of the length of the second sequence are/is determined based on the modulation order of the first signal and/or the modulation order of the second signal.

In some implementations, the length of the first sequence is associated with the modulation order of the first signal, there is a second association relationship between the length of the first sequence and the modulation order of the first signal, and the second association relationship is used to indicate one or more of the following: a modulation order of one first signal being corresponding to lengths of a plurality of first sequences; modulation orders of a plurality of first signals being corresponding to a length of one first sequence; or a modulation order of one first signal being corresponding to a length of one first sequence.

In some implementations, a modulation order of one first signal is corresponding to lengths of a plurality of first sequences. For example, if the modulation order of the first signal is M, a value range of the length of the first sequence is L={4*M, 6*M, 8*M, 12*M}. Specifically, if a value of M is 1, the value range of the length of the first sequence is L={4,6,8}; if the value of M is 2, the value range of the length of the first sequence is L={8,12,16,24}; and if the value of M is 4, the value range of the length of the first sequence is L={16,24,32,56}.

In some implementations, a modulation order of one first signal is corresponding to a length of one first sequence. In other words, the length of the first sequence is in a one-to-one correspondence with the modulation order of the first signal. For example, the modulation order of the first signal is M, and the length of the first sequence is L. During determining of L corresponding to different M values, a number of OFDM symbols used for transmitting the first signal may remain unchanged for different values of M regardless of the values of M. In order to prevent the terminal device from blindly detecting the first signal having different numbers of OFDM symbols in an idle/inactive mode, a corresponding value of L when M is 1, 2, or 4 may be scaled together with the value of M, so that a number of OFDM symbols for different values of M is the same. For another example, if the value of M is 1, the selected length of the first sequence is L1=8; correspondingly, when M is 2, the length of the first sequence is L2, and when M is 4, the length of the first sequence is L3, for example, L2=16 and L3=32.

In some implementations, modulation orders of a plurality of first signals are corresponding to a length of one first sequence. For example, the modulation order of the first signal is M, the length of the first sequence is L, and L may remain unchanged for different values of M.

In some implementations, the length of the first sequence and/or the length of the second sequence are/is associated with the modulation order of the first signal and/or the modulation order of the second signal and the number of transmission resource blocks of the first signal and/or the number of transmission resource blocks of the second signal. That is, the length of the first sequence and/or the second sequence are/is determined based on the modulation order of the first signal and/or the modulation order of the second signal and the number of transmission resource blocks of the first signal and/or the number of transmission resource blocks of the second signal.

In some implementations, the basic sequence is a ZC sequence, and the length of the first sequence and/or the length of the second sequence meet/meets at least one of the following: L_{ZC}=2^{k}/M, where 2^{k}≤12*X; or L_{ZC}=(2*X)/M, where M is the modulation order of the first signal and/or the modulation order of the second signal, and X is the number of transmission resource blocks of the first signal and/or the number of transmission resource blocks of the second signal. For example, the modulation order of the second signal is M, the number of transmission resource blocks (resource block, RB) of the second signal is X, the basic sequence is generated based on the ZC sequence, and the length of the second sequence is calculated by formula L_{ZC}=2k/M, where 2^{k}≤12*X, and the value of M may be 1, 2, or 4, or other even numbers. For another example, the length of the second sequence is determined by formula L_{ZC}=(12*X)/M.

In some implementations, the length of the first sequence and/or the length of the second sequence are/is associated with the modulation order of the first signal and/or the modulation order of the second signal and the length of the basic sequence. For example, the modulation order of the second signal is M, the basic sequence is a ZC sequence, and the length of the ZC sequence is N_{ZC}. If the value of M is 1, and N_{ZC} is a given prime number, the length of the second sequence meets N_{ZC}<L_{ZC}; and if the value of M is 2 or 4, and N_{ZC} is a given prime number, the length of the second sequence meets N_{ZC}<L_{ZC}−2*GO, where GO is a value set by the system.

In some implementations, the length of the first sequence and/or the length of the second sequence are/is associated with the subcarrier spacing. For example, the length of the first sequence is L. In a multi-carrier system, different SCSs may affect a signal bandwidth and time resolution of each subcarrier. Therefore, a configuration of a value of L needs to adapt to different SCSs to optimize detection performance.

In some implementations, that the length of the first sequence and/or the length of the second sequence are/is associated with the subcarrier spacing may be understood as that the length of the first sequence and/or the length of the second sequence are/is determined based on a configuration strategy, and the configuration strategy is used to indicate one or more of the following: an SCS value of 15 kHz, which is suitable for the first signal and/or the second signal having a low bandwidth and a long symbol time, and is suitable for a relatively large value of L (such as L=24 or L=32, or 8*M, or 12*M) to smooth signal detection; an SCS value of 30 kHz, which is suitable for application scenarios of a medium bandwidth, where a medium value of L (such as L=8 or L=16, or 4*M, or 6*M) may be used to balance a bandwidth and detection accuracy; an SCS value of 60 kHz, which is suitable for the first signal and/or the second signal having high-speed transmission and a short symbol time, and is suitable for a relatively small value of L (such as L=4 or L=6) to ensure fast detection and a low delay; where M is the modulation order of the first signal and/or the modulation order of the second signal.

In some implementations, the length of the first sequence and/or the length of the second sequence are/is associated with the channel state information and the subcarrier spacing. For example, the network device may monitor a channel condition and dynamically adjust the length of the first sequence and/or the length of the second sequence to ensure the best detection performance of the terminal device of the first signal and/or the second signal under different SCSs.

In some implementations, the length of the first sequence and/or the length of the second sequence are/is associated with the channel state information. For example, if the first signal is an LP-SS and channel estimation is inaccurate, a relatively large length of the first sequence is selected to enhance autocorrelation performance of the LP-SS, thereby improving synchronization accuracy. For another example, the channel state information includes a signal-to-noise ratio and an interference intensity, and two thresholds are defined: a signal-to-noise ratio threshold SNRthreshold and an interference intensity threshold threshold. If SNR ≥ SNRthreshold and I≤threshold, a channel state is considered to be “low noise/low interference”; or if SNR <SNRthreshold or I >threshold, a channel state is considered to be “high noise/high interference”. Based on the foregoing determining of the channel state, a relatively small length of the first sequence is selected in a low-noise environment, or a relatively large length of the first sequence is selected in a high-interference environment.

In some implementations, the length of the first sequence and/or the length of the second sequence are/is associated with the channel state information and the detection requirement of the terminal device. For example, the network device may dynamically select an optimal length of the first sequence and/or an optimal length of the second sequence based on a real-time channel condition and the detection requirement of the terminal device.

Since a moving terminal device may cause a Doppler shift, a frequency spectrum of the first signal and/or a frequency spectrum of the second signal may be offset, which results in a decrease in detection accuracy of the terminal device. In some implementations, the length of the first sequence and/or the length of the second sequence are/is associated with the mobility of the terminal device. For example, high mobility (such as a terminal device traveling at high speed) may cause rapid frequency offsets. Therefore, in a high-mobility scenario, selecting a relatively large length of the first sequence and/or a relatively large length of the second sequence is conducive to reducing impact of a Doppler effect on detection.

In some implementations, the length of the first sequence and/or the length of the second sequence are/is associated with the power consumption of the terminal device. For example, in a power-constrained environment (for example, the terminal device is a battery-powered Internet of Things (internet of things, IoT) device), since longer sequences increase computational complexity and power consumption, selecting a shorter length of the first sequence and/or a shorter length of the second sequence can help extend a battery life of the terminal device.

In some implementations, the length of the first sequence and/or the length of the second sequence are/is associated with the channel state information and the mobility of the terminal device. In other words, the length of the first sequence and/or the length of the second sequence are/is associated with a weighted sum of the channel state information and the mobility of the terminal device. For example, the channel state information includes a signal-to-noise ratio, interference intensity, and multipath effect. The weights of the signal-to-noise ratio, the interference intensity, the multipath effect, and the mobility of the terminal device are separately defined, and a weighted sum of the four factors is used to determine the length of the first sequence and/or the length of the second sequence.

In some implementations, the weights of the channel state information and the mobility of the terminal device may be determined based on application requirements.

In some implementations, the application requirements may be understood as application scenarios of a communications system. For example, the application requirements may be application scenarios (such as enhance mobile broadband (enhance mobile broadband, eMBB), ultra-reliable low-latency communications (ultra-reliable low-latency communications, uRLLC), and massive machine type communication (massive machine type communication, mMTC)) in 5G systems, or future 6G application scenarios (such as integrated communication and sensing).

In some implementations, the modulation order and the length of the first sequence and/or the length of the second sequence may be combined based on the SCS to adapt to different detection requirements. For example, the modulation order of the first signal is M. For different SCS values (such as 15 kHz and 30 kHz), the same M and different lengths of the first sequence are supported, or different M and different lengths of the first sequence are supported, or different M and the same length of the first sequence are supported.

Channel coding may use redundant information to combat a fading channel of the LP-WUR, which may improve detection and decoding performance of the first signal and/or the second signal. Usually, channel coding schemes require highly complex decoding algorithms (that is, Polar codes and low-density parity-check (low-density parity-check, LDPC) codes) and high power consumption to improve signal detection and decoding performance.

In some implementations, the coding scheme of the first signal and/or the coding scheme of the second signal may be Manchester coding. Manchester coding is a simple solution that provides a balanced sequence having equal numbers of Os and Is and a limited length of consecutive zeros. Manchester coding systematically enforces power balancing within each OFDM symbol and within each ON symbol of any modulation order, which ensures full power utilization of the network device and is conducive to automatic gain control (automatic gain control, AGC) tracking. In a case of correlation mismatch, an autocorrelation function of the Manchester coded sequence is correlated with an autocorrelation function of a bipolar sequence before Manchester coding. Therefore, Manchester coding may systematically tend to create sequences having narrower autocorrelation main lobes, which is relevant for simulation assumption of the first signal of a small detection window considered.

For ease of understanding, the following describes an example of encoding the first signal by using Manchester coding.

It is assumed that the first signal is an LP-SS, and the LP-SS after OOK modulation is a binary sequence having a length of L of 4. The first sequence is determined based on a candidate sequence, the candidate sequence is obtained after extension, truncation, cyclic shift, extraction, and other operations are performed on an M-sequence M [n] having a length Lₘ. The candidate sequence before Manchester coding may be written as s_{(f,cp,cad)}[n]=f ⊕m[d(n+c_{b})mod Lₘ+Cₐ] where n=0, . . . , and L′−1. A set of element groups (f, c_{b}, cₐ, d), f∈{0,1} is defined to return either a sequence or a binary complement thereof, Cₐ∈ {0, . . . , Lₘ−1} is a shift step size before extension/truncation, c_{b} ∈{0, . . . , L′−1} is a shift step size after extension/truncation, and d is decimation, where gcd (d, L′)=1 is met. If the first sequence is Manchester coded, L′=L/2, and if the first sequence is not Manchester coded, L′=L. s_{(f.cn,cad)}[n], is a sequence having similar autocorrelation characteristics among all possible sequences that are generated, so as to provide uniform timing performance between cells. Since timing estimation is performed within a relatively small search window, the terminal device may search for sequences with less correlation around a main peak to reduce a main lobe width, and then minimize peak sidelobes in the rest of an autocorrelation profile to further minimize maximum cross-correlation.

In some implementations, when the first receiver of the terminal device receives second signals, if a subgroup indicated by some of the second signals does not match a subgroup of the terminal device, the terminal device stops receiving subsequent second signals. For example, the second signal is an LP-WUS, and a modulation scheme of the second signal is OOK. Referring to FIG. 4, if one LP-WUS can include a plurality of OFDM symbols, no matter how long a bit stream is, the bit stream may be processed and transmitted one OFDM symbol at a time. On a side of the first receiver, the LP-WUR demodulates the OOK signal or processes a same set of sequences used to generate a pre-DFT sequence on each OFDM symbol. The LP-WUR does not need to buffer all resources of the LP-WUS. Because a subgroup identity (identity, ID) indicated by the LP-WUS is known in advance by the terminal device, if the terminal device finds that a subgroup indicated by a bit of the LP-WUS received at the first several LP-WUS occasions does not match a subgroup identity of the terminal device, the terminal device may stop receiving subsequent LP-WUS to save power.

In order to ensure that a total power level of the first signal and/or a total power level of the second signal are/is consistent when overlaying OFDM, in some implementations, a power of the first signal and/or a power of the second signal are/is allocated based on one or more of the following: an activated subcarrier; symbol positions of the OFDM; or a peak-to-average power ratio (peak to average power ratio, PAPR) detection result.

In some implementations, the power of the first signal and/or the power of the second signal are/is uniformly distributed on the activated subcarrier. For example, the modulation scheme of the first signal is OOK. In order to uniformly distribute the total power of the first signal on all activated subcarriers, it is ensured that a total power of OOK ON symbols on all subcarriers is equal, to avoid concentration of the power on a single subcarrier or a few subcarriers, thereby reducing a peak power and maintaining consistency in detection performance. It is assumed that the total power is Pₜₒₜₐₗ, and there are Non subcarriers that are activated. Then, a power of each activated subcarrier is P_{sub}=Pₜₒₜₐₗ/Nₒₙ, indicating that an equal power P_{sub} is allocated to each activated subcarrier. This manner ensures that the total power of all activated subcarriers is stabilized to be equal to or less than Pₜₒₜₐₗ within an entire OFDM frame.

In some implementations, the power of the first signal and/or the power of the second signal are/is determined based on the symbol positions of the OFDM. For example, the modulation scheme of the first signal is OOK. In multi-symbol OFDM, the power is dynamically adjusted based on a position of a symbol to ensure smooth power changes between ON symbols and OFF symbols of OOK, thereby preventing detection errors caused by instantaneous power changes. Specifically, the total power of the first signal may be allocated to each OFDM symbol frame, and the power may be adjusted in different frames based on a frequency deviation to make the power uniform.

In some implementations, a power of a symbol frame used for transmitting the first signal and/or a power of a symbol frame used for transmitting the second signal is determined by formula p=α*p′+(1−α)*pₜₒₜₐₗ/Nₒₙ, where a is a smoothing factor, p′ is a power of a previous symbol frame, pₜₒₜₐₗ is a total power of the first signal and/or a total power of the second signal, and Nₒₙ is a number of activated subcarriers.

In some implementations, a value of the smoothing factor α may be adjusted according to a requirement, and is usually recommended to be between 0.8 and 0.9 to avoid drastic power changes.

In some implementations, the power of the first signal and/or the power of the second signal are/is allocated based on the PAPR detection result. For example, PAPR detection is performed on each symbol frame, and if a power peak of some subcarriers exceeds a set threshold, peak clipping is performed.

In some implementations, peak clipping may be implemented by limiting an upper limit of a power of a single subcarrier, or reallocating a power of a high-power subcarrier to other low-power subcarriers.

In some implementations, power distribution after peak clipping needs to be evenly distributed within the symbol frame to avoid abnormal prominence of powers of some subcarriers in frequency domain.

In some implementations, a power after peak clipping is distributed according to a subcarrier number, and the power is allocated in decreasing or increasing directions toward both sides, for example, gradually reducing the power towards edges based on a center subcarrier.

In some implementations, a structure of an OFDM symbol used for transmitting the first signal and/or a structure of an OFDM symbol used for transmitting the second signal are/is configured by the network device, and the OFDM symbol includes one or more intervals. For example, refer to FIG. 5. FIG. 5 shows a structure of an OFDM symbol used for transmitting a second signal. The second signal is obtained by overlaying the second sequence on OFDM in time domain or frequency domain. For example, the modulation scheme of the second signal is OOK-4, gaps are inserted at the beginning and end of each OOK symbol of OOK-4(example a), that is, a gap having a length of GO is added at the beginning and end of each OOK symbol A value of GO is determined by a maximum time error value before detection of the second signal, and GO may suppress degradation of detection performance of the second signal caused by a relatively large remaining time error. The maximum time error value before the detection of the second signal may determine different positions of GO, for example, four examples: a, b, c, and d, and different time errors may lead to different symbol structures.

In some implementations, the network device may configure a structure of one or more OFDM symbols. For example, the network device is configured with a fixed structure of an OFDM symbol, such as example a in FIG. 5. For another example, the network device is configured with a plurality of structures of OFDM symbols and selects a structure of an OFDM symbol based on the time error before the detection of the second signal.

In some implementations, the first signal carries cell identity information.

In some implementations, the cell identity information may be a cell ID. For example, the first signal is an LP-SS, and the LP-SS carries a cell ID. In LP-SS transmission based on a predefined rule, the terminal device may select any cell. For example, during a cell (re) selection process, the terminal device may potentially determine a cell setting based on a cell ID carried in an LP-SS received from any adjacent non-serving cells.

In some implementations, that the first signal carries cell identity information may be understood as that an information module following a preamble of the first signal carries the cell ID to trigger sequence detection. For example, referring to FIG. 6, the information module of the first signal carries the cell ID.

In some implementations, that the first signal carries cell identity information may be understood as that the information module following the preamble of the first signal carries a truncated cell ID. For example, referring to FIG. 6, the information module of the first signal is used to carry truncated cell ID information through four binary sequences, and the fixed known preamble is connected to the truncated cell ID information module.

In some implementations, before the terminal device receives the first signal and/or the second signal, the terminal device may receive a first information transmitted by the network device, where the first information is used to indicate an update of the first sequence and/or an update of the second sequence. Accordingly, before the network device transmits the first signal and/or the second signal, the network device transmits the first information to the terminal device. For example, the first signal is an LP-SS. When configuring the first sequence corresponding to the LP-SS, the network device may dynamically change the first sequence. The network device may indicate the update of the first sequence to the terminal device by using the first information before transmitting the LP-SS.

In some implementations, the first information may be carried in a downlink control information (downlink control information, DCI) and/or an RRC message.

The method embodiments of the present application are described in detail above with reference to FIG. 1 to FIG. 6. Apparatus embodiments of the present application are described in detail below with reference to FIG. 7 to FIG. 9. It should be understood that the description of the method embodiments corresponds to the description of the apparatus embodiments, and therefore, for a part that is not described in detail, reference may be made to the foregoing method embodiments.

FIG. 7 is a schematic diagram of a terminal device according to an embodiment of the present application. The terminal device 700 shown in FIG. 7 includes a receiving unit 710.

The receiving unit 710 is configured to receive one or more of the following transmitted by a network device: a first signal and a second signal, where the second signal is received based on the first signal; or the second signal, where the first signal and/or the second signal are/is obtained by overlaying a first sequence and/or a second sequence on orthogonal frequency division multiplexing OFDM in time domain or frequency domain, the first signal and/or the second signal are/is received by a first receiver of the terminal device, and power consumption of the first receiver is less than power consumption of a second receiver of the terminal device.

In some implementations, the first signal is a low power synchronization signal LP-SS.

In some implementations, the second signal is a low-power wake-up signal LP-WUS.

In some implementations, timing information of the first signal is determined based on timing information of a third signal; and/or a time resource occupied by the first signal overlap with a time resource occupied by the third signal; and/or the first signal and the third signal have a quasi co-location QCL relationship; and/or the third signal includes one or more of the following: a synchronization signal/physical broadcast channel block SSB; an SSB burst set; or a primary synchronization signal PSS/secondary synchronization signal SSS in an SSB.

In some implementations, an information bit of the second signal is carried in overlaid OFDM, and a size of the information bit is associated with one or more of the following: information content carried in the second signal; a code rate of the second signal; a number of paging occasions POs of the second signal; a number of terminal devices indicated by the POs; or a number of times the second signal is monitored.

In some implementations, the size of the information bit is further associated with one or more of the following: network configuration information; a number of cells in a tracking area; density of terminal devices in a cell; or a current arriving traffic volume.

In some implementations, the first sequence and the second sequence have a first association relationship, and the first association relationship is used to indicate one or more of the following: the first sequence being the same as the second sequence; the first sequence being different from the second sequence; a modulation order of the first sequence being the same as a modulation order of the second sequence; a modulation order of the first sequence being different from a modulation order of the second sequence; or a modulation order of the first sequence being greater than or equal to a modulation order of the second sequence.

In some implementations, the first sequence and/or the second sequence are/is determined based on one or more of the following: a preconfigured sequence; a predefined sequence; or one or more candidate sequences.

In some implementations, the candidate sequence is obtained by performing at least one of the following operations on a basic sequence: cyclic shift; extension; or truncation.

In some implementations, the candidate sequence is obtained by padding zeros before and/or after the extension of the basic sequence, and a total number of zeros is determined by formula N₀=L−N, where L is a length of the candidate sequence, and N is a length of the basic sequence.

In some implementations, the cyclic shift includes one or more step sizes.

In some implementations, the basic sequence is a ZC sequence, and the ZC sequence includes one or more root sequences.

In some implementations, the root sequences of the ZC sequence and/or a step size of the cyclic shift are/is determined based on one or more of the following: a modulation order of the first signal and/or a modulation order of the second signal; a length of the basic sequence; network load information; channel state information; an inter-cell interference condition; or a timing error of the terminal device.

In some implementations, the step size of the cyclic shift is determined by formula

$${C}_{V} \geq \frac{{N}_{ZC}}{M} ,$$

where N_{ZC} is a length of the ZC sequence, and M is the modulation order of the first signal and/or the modulation order of the second signal.

In some implementations, the basic sequence is an M-sequence, and the M-sequence is generated based on one or more generator polynomials.

In some implementations, a step size of a cyclic shift of the M-sequence meets

$${C}_{V} ∈ [ \frac{{N}_{M}}{4} , \frac{3 {N}_{M}}{4} ] ,$$

where C_{V} is the step size of the cyclic shift of the M-sequence, and N_{M} is a length of the M-sequence.

In some implementations, a length of the first sequence and/or a length of the second sequence are/is associated with one or more of the following: a number of transmission resource blocks of the first signal and/or a number of transmission resource blocks of the second signal; a modulation order of the first signal and/or a modulation order of the second signal; a length of the basic sequence; a subcarrier spacing; channel state information; mobility of the terminal device; power consumption of the terminal device; or a detection requirement of the terminal device.

In some implementations, the basic sequence is a ZC sequence, and the length of the first sequence and/or the length of the second sequence meet/meets at least one of the following: L_{ZC}=2^{k}/M, where 2^{k}≤12*X; or L_{ZC}=(2*X)/M, where M is the modulation order of the first signal and/or the modulation order of the second signal, and X is the number of transmission resource blocks of the first signal and/or the number of transmission resource blocks of the second signal.

In some implementations, there is a second association relationship between the length of the first sequence and the modulation order of the first signal, and the second association relationship is used to indicate one or more of the following: a modulation order of one first signal being corresponding to lengths of a plurality of first sequences; modulation orders of a plurality of first signals being corresponding to a length of one first sequence; or a modulation order of one first signal being corresponding to a length of one first sequence.

In some implementations, a power of the first signal and/or a power of the second signal are/is allocated based on one or more of the following: an activated subcarrier; symbol positions of the OFDM; or a peak-to-average power ratio PAPR detection result.

In some implementations, the power of the first signal and/or the power of the second signal are/is uniformly distributed on the activated subcarrier.

In some implementations, a power of a symbol frame used for transmitting the first signal and/or a power of a symbol frame used for transmitting the second signal is determined by formula p=α*p′+(1−α)*Pₜₒₜₐₗ/Nₒₙ, where a is a smoothing factor, p′ is a power of a previous symbol frame, pₜₒₜₐₗ is a total power of the first signal and/or a total power of the second signal, and Nₒₙ is a number of activated subcarriers.

In some implementations, a modulation scheme of the first signal and/or a modulation scheme of the second signal are/is on-off keying OOK.

In some implementations, a coding scheme of the first signal and/or a coding scheme of the second signal are/is Manchester coding.

In some implementations, a structure of an OFDM symbol used for transmitting the first signal and/or a structure of an OFDM symbol used for transmitting the second signal are/is configured by the network device, and the OFDM symbol includes one or more intervals.

In some implementations, the first signal carries cell identity information.

In some implementations, before the receiving unit receives the first signal and/or the second signal, the terminal device further includes: the receiving unit 710 is further configured to receive a first information transmitted by the network device, where the first information is used to indicate an update of the first sequence and/or an update of the second sequence.

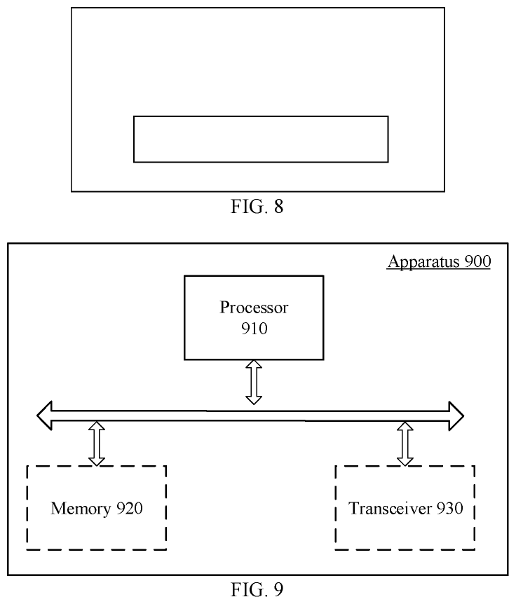

FIG. 8 is a schematic diagram of a network device according to an embodiment of the present application. The network device 800 shown in FIG. 8 includes a transmitting unit 810.

The transmitting unit 810 is configured to transmit one or more of the following to a terminal device: a first signal and a second signal, where the second signal is received based on the first signal; or the second signal, where the first signal and/or the second signal are/is obtained by overlaying a first sequence and/or a second sequence on orthogonal frequency division multiplexing OFDM in time domain or frequency domain, the first signal and/or the second signal are/is received by a first receiver of the terminal device, and power consumption of the first receiver is less than power consumption of a second receiver of the terminal device.

In some implementations, the first signal is a low power synchronization signal LP-SS.

In some implementations, the second signal is a low-power wake-up signal LP-WUS.

In some implementations, timing information of the first signal is determined based on timing information of a third signal; and/or a time resource occupied by the first signal overlap with a time resource occupied by the third signal; and/or the first signal and the third signal have a quasi co-location QCL relationship; and/or the third signal includes one or more of the following: a synchronization signal/physical broadcast channel block SSB; an SSB burst set; or a primary synchronization signal PSS/secondary synchronization signal SSS in an SSB.

In some implementations, an information bit of the second signal is carried in overlaid OFDM, and a size of the information bit is associated with one or more of the following: information content carried in the second signal; a code rate of the second signal; a number of paging occasions POs of the second signal; a number of terminal devices indicated by the POs; or a number of times the second signal is monitored.

In some implementations, the size of the information bit is further associated with one or more of the following: network configuration information; a number of cells in a tracking area; density of terminal devices in a cell; or a current arriving traffic volume.

In some implementations, the first sequence and the second sequence have a first association relationship, and the first association relationship is used to indicate one or more of the following: the first sequence being the same as the second sequence; the first sequence being different from the second sequence; a modulation order of the first sequence being the same as a modulation order of the second sequence; a modulation order of the first sequence being different from a modulation order of the second sequence; or a modulation order of the first sequence being greater than or equal to a modulation order of the second sequence.

In some implementations, the first sequence and/or the second sequence are/is determined based on one or more of the following: a preconfigured sequence; a predefined sequence; or one or more candidate sequences.

In some implementations, the candidate sequence is obtained by performing at least one of the following operations on a basic sequence: cyclic shift; extension; or truncation.

In some implementations, the candidate sequence is obtained by padding zeros before and/or after the extension of the basic sequence, and a total number of zeros is determined by formula N₀=L−N, where L is a length of the candidate sequence, and N is a length of the basic sequence.

In some implementations, the cyclic shift includes one or more step sizes.

In some implementations, the basic sequence is a ZC sequence, and the ZC sequence includes one or more root sequences.

In some implementations, the root sequences of the ZC sequence and/or a step size of the cyclic shift are/is determined based on one or more of the following: a modulation order of the first signal and/or a modulation order of the second signal; a length of the basic sequence; network load information; channel state information; an inter-cell interference condition; or a timing error of the terminal device.

In some implementations, the step size of the cyclic shift is determined by formula

$${C}_{V} \geq \frac{{N}_{ZC}}{M} ,$$

where N_{ZC} is a length of the ZC sequence, and M is the modulation order of the first signal and/or the modulation order of the second signal.

In some implementations, the basic sequence is an M-sequence, and the M-sequence is generated based on one or more generator polynomials.

In some implementations, a step size of a cyclic shift of the M-sequence meets

$${C}_{V} ∈ [ \frac{{N}_{M}}{4} , \frac{3 {N}_{M}}{4} ] ,$$

where C_{V} is the step size of the cyclic shift of the M-sequence, and N_{M} is a length of the M-sequence.

In some implementations, a length of the first sequence and/or a length of the second sequence are/is associated with one or more of the following: a number of transmission resource blocks of the first signal and/or a number of transmission resource blocks of the second signal; a modulation order of the first signal and/or a modulation order of the second signal; a length of the basic sequence; a subcarrier spacing; channel state information; mobility of the terminal device; power consumption of the terminal device; or a detection requirement of the terminal device.

In some implementations, the basic sequence is a ZC sequence, and the length of the first sequence and/or the length of the second sequence meet/meets at least one of the following: L_{ZC}=2^{k}/M, where 2^{k}≤12*X; or L_{ZC}=(2*X)/M, where M is the modulation order of the first signal and/or the modulation order of the second signal, and X is the number of transmission resource blocks of the first signal and/or the number of transmission resource blocks of the second signal.

In some implementations, there is a second association relationship between the length of the first sequence and the modulation order of the first signal, and the second association relationship is used to indicate one or more of the following: a modulation order of one first signal being corresponding to lengths of a plurality of first sequences; modulation orders of a plurality of first signals being corresponding to a length of one first sequence; or a modulation order of one first signal being corresponding to a length of one first sequence.

In some implementations, a power of the first signal and/or a power of the second signal are/is allocated based on one or more of the following: an activated subcarrier; symbol positions of the OFDM; or a peak-to-average power ratio PAPR detection result.

In some implementations, the power of the first signal and/or the power of the second signal are/is uniformly distributed on the activated subcarrier.

In some implementations, a power of a symbol frame used for transmitting the first signal and/or a power of a symbol frame used for transmitting the second signal is determined by formula p=α*p′+(1−α)*Pₜₒₜₐₗ/Nₒₙ, where a is a smoothing factor, p′ is a power of a previous symbol frame, Pₜₒₜₐₗ is a total power of the first signal and/or a total power of the second signal, and Nₒₙ is a number of activated subcarriers.

In some implementations, a modulation scheme of the first signal and/or a modulation scheme of the second signal are/is on-off keying OOK.

In some implementations, a coding scheme of the first signal and/or a coding scheme of the second signal are/is Manchester coding.

In some implementations, a structure of an OFDM symbol used for transmitting the first signal and/or a structure of an OFDM symbol used for transmitting the second signal are/is configured by the network device, and the OFDM symbol includes one or more intervals. In some implementations, the first signal carries cell identity information.

In some implementations, before the transmitting unit transmits the first signal and/or the second signal, the network device further includes: the transmitting unit 810 is further configured to transmit first information to the terminal device, where the first information is used to indicate an update of the first sequence and/or an update of the second sequence.

In an optional embodiment, the receiving unit 710 may be a transceiver 930. The terminal device 700 may further include a processor 910 and a memory 920, which are specifically shown in FIG. 9.

In an optional embodiment, the transmitting unit 810 may be a transceiver 930. The network device 800 may further include a processor 910 and a memory 920, which are specifically shown in FIG. 9.

FIG. 9 is a schematic structural diagram of a communications apparatus according to an embodiment of the present application. Dashed lines in FIG. 9 indicate that a unit or module is optional. The apparatus 900 may be configured to implement the methods described in the foregoing method embodiments. The apparatus 900 may be a chip, a terminal device, or a network device.

The apparatus 900 may include one or more processors 910. The processor 910 may support the apparatus 900 in implementing the methods described in the foregoing method embodiments. The processor 910 may be a general-purpose processor or a dedicated processor. For example, the processor may be a central processing unit (central processing unit, CPU). Alternatively, the processor may be another general-purpose processor, a digital signal processor (digital signal processor, DSP), an application-specific integrated circuit (application specific integrated circuit, ASIC), a field-programmable gate array (field programmable gate array, FPGA) or another programmable logic device, a discrete gate or transistor logic device, a discrete hardware component, or the like. The general-purpose processor may be a microprocessor, or the processor may be any conventional processor or the like.

The apparatus 900 may further include one or more memories 920. The memory 920 stores a program, and the program may be executed by the processor 910, so that the processor 910 performs the methods described in the foregoing method embodiments. The memory 920 may be independent of or integrated into the processor 910.

The apparatus 900 may further include a transceiver 930. The processor 910 may communicate with another device or chip by using the transceiver 930. For example, the processor 910 may transmit data to and receive data from another device or chip by using the transceiver 930.

An embodiment of the present application further provides a computer-readable storage medium for storing a program. The computer-readable storage medium may be applied to the terminal device or the network device provided in embodiments of the present application, and the program causes a computer to execute the methods performed by the terminal device or the network device in various embodiments of the present application.

An embodiment of the present application further provides a computer program product. The computer program product includes a program. The computer program product may be applied to the terminal device or the network device provided in embodiments of the present application, and the program causes a computer to perform the methods performed by the terminal device or the network device in various embodiments of the present application.

An embodiment of the present application further provides a computer program. The computer program may be applied to a terminal device or a network device provided in embodiments of the present application, and the computer program causes a computer to perform the methods performed by the terminal device or the network device in various embodiments of the present application.

It should be understood that the terms “system” and “network” in the present application may be used interchangeably. In addition, the terms used in the present application are merely used to explain the specific embodiments of the present application, and are not intended to limit the present application. In the specification, claims, and accompanying drawings of the present application, the terms “first”, “second”, “third”, “fourth”, and so on are intended to distinguish between different objects but do not describe a particular sequence. In addition, the terms “include” and “have” and any variations thereof are intended to cover a non-exclusive inclusion.

In embodiments of the present application, “indicate” mentioned herein may be a direct indication, or may be an indirect indication, or may mean that there is an association relationship. For example, A indicates B, which may mean that A directly indicates B, for example, B may be obtained by using A; or may mean that A indirectly indicates B, for example, A indicates C, and B may be obtained by using C; or may mean that there is an association relationship between A and B.

In embodiments of the present application, the term “correspond” may mean that there is a direct or indirect correspondence between the two, or may mean that there is an association relationship between the two, or may mean that there is a relationship such as indicating and being indicated, or configuring and being configured.

In embodiments of the present application, “pre-defined” or “pre-configured” may be implemented by pre-storing, in devices (for example, including a terminal device and a network device), corresponding code, tables, or other forms that may be used to indicate related information, and a specific implementation thereof is not limited in the present application. For example, being predefined may refer to being defined in a protocol.

In embodiments of the present application, the “protocol” may refer to a standard protocol in the communications field, and may include, for example, an LTE protocol, an NR protocol, and a related protocol applied to a future communications system, which is not limited in the present application.

In embodiments of the present application, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

In several embodiments provided in the present application, it should be understood that, the disclosed system, apparatus, and method may be implemented in other manners. For example, the foregoing described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or another form.

The units described as separate parts may be or may not be physically separate, and parts displayed as units may be or may not be physical units, and may be at one location, or may be distributed on a plurality of network elements. A part or all of the units may be selected based on actual requirements to achieve the objectives of the solutions of embodiments.

In addition, functional units in embodiments of the present application may be integrated into one processing unit, or each of the units may exist alone physically, or two or more units may be integrated into one unit.

All or a part of the foregoing embodiments may be implemented by using software, hardware, firmware, or any combination thereof. When the software is used to implement embodiments, all or a part of embodiments may be implemented in a form of a computer program product. The computer program product includes one or more computer instructions. When the computer program instructions are loaded and executed on a computer, the procedures or functions according to embodiments of the present application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from one website, computer, server, or data center to another website, computer, server, or data center in a wired (such as a coaxial cable, an optical fiber, and a digital subscriber line (digital subscriber line, DSL)) manner or a wireless (such as infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (digital video disc, DVD)), a semiconductor medium (for example, a solid state drive (solid state drive SSD)), or the like.

The foregoing descriptions are merely specific implementations of the present application, but the protection scope of the present application is not limited thereto. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. A wireless communication method, comprising:
receiving, by a terminal device, one or more of following transmitted by a network device:
a first signal and a second signal, wherein the second signal is received based on the first signal; or
the second signal;
wherein at least one of the first signal or the second signal is obtained by overlaying a first sequence or a second sequence on orthogonal frequency division multiplexing (OFDM) in at least one of a time domain and a frequency domain, at least one of the first signal or the second signal is received by a first receiver of the terminal device, and power consumption of the first receiver is less than power consumption of a second receiver of the terminal device.

2. The method according to claim 1, wherein the first signal is a low power synchronization signal (LP-SS).

3. The method according to claim 1, wherein the second signal is a low-power wake-up signal (LP-WUS).

4. The method according to claim 1, wherein at least one of the following is true:
timing information of the first signal is determined based on timing information of a third signal;
a time resource occupied by the first signal overlap with a time resource occupied by the third signal;
the first signal and the third signal have a quasi co-location (QCL) relationship; or
the third signal comprises one or more of following: a synchronization signal/physical broadcast channel block (SSB); an SSB burst set; or a primary synchronization signal (PSS)/secondary synchronization signal (SSS) in an SSB.

5. The method according to claim 1, wherein an information bit of the second signal is carried in overlaid OFDM, and a size of the information bit is associated with one or more of following:
information content carried in the second signal;
a code rate of the second signal;
a number of paging occasions (POs) of the second signal;
a number of terminal devices indicated by the POs; or
a number of times the second signal is monitored.

6. The method according to claim 5, wherein the size of the information bit is further associated with one or more of following:
network configuration information;
a number of cells in a tracking area;
density of terminal devices in a cell; or
a current arriving traffic volume.

7. The method according to claim 1, wherein the first sequence and the second sequence have a first association relationship, and the first association relationship indicates at least one of following:
the first sequence being the same as the second sequence;
the first sequence being different from the second sequence;
a modulation order of the first sequence being the same as a modulation order of the second sequence;
a modulation order of the first sequence being different from a modulation order of the second sequence; or
a modulation order of the first sequence being greater than or equal to a modulation order of the second sequence.

8. The method according to claim 1, wherein at least one of the first sequence or the second sequence is determined based on at least one of following:
a preconfigured sequence;
a predefined sequence; or
one or more candidate sequences.

9. The method according to claim 8, wherein the candidate sequence is obtained by performing at least one of the following operations on a basic sequence: cyclic shift; extension;
or truncation.

10. The method according to claim 9, wherein the candidate sequence is obtained by padding zeros before or after the extension of the basic sequence, and a total number of zeros is determined by formula N₀=L−N, wherein
L is a length of the candidate sequence, and N is a length of the basic sequence.

11. The method according to claim 9, wherein the cyclic shift comprises one or more step sizes.

12. The method according to claim 9, wherein the basic sequence is a ZC sequence, and the ZC sequence comprises one or more root sequences, wherein at least one of the root sequences of the ZC sequence or a step size of the cyclic shift is determined based on at least one of following:
at least one of a modulation order of the first signal or a modulation order of the second signal;
a length of the basic sequence;
network load information;
channel state information;
an inter-cell interference condition; or
a timing error of the terminal device.

13. The method according to claim 12, wherein the step size of the cyclic shift is determined based on
$${C}_{V} \geq \frac{{N}_{ZC}}{M} ,$$
wherein
C_{V} is the step size of the cyclic shift, N_{ZC} is a length of the ZC sequence, and M is at least one of the modulation order of the first signal or the modulation order of the second signal.

14. The method according to claim 9, wherein the basic sequence is an M-sequence, and the M-sequence is generated based on one or more generator polynomials, wherein a step size of a cyclic shift of the M-sequence meets
$${C}_{V} ∈ [ \frac{{N}_{M}}{4} , \frac{3 {N}_{M}}{4} ] ,$$
wherein
C_{V} is the step size of the cyclic shift of the M-sequence, and N_{M} is a length of the M-sequence.

15. The method according to claim 1, wherein at least one of a length of the first sequence or a length of the second sequence is associated with at least one of following:
at least one of a number of transmission resource blocks of the first signal or a number of transmission resource blocks of the second signal;
at least one of a modulation order of the first signal or a modulation order of the second signal;
a length of a basic sequence;
a subcarrier spacing;
channel state information;
mobility of the terminal device;
power consumption of the terminal device; or
a detection requirement of the terminal device.

16. The method according to claim 15, wherein the basic sequence is a ZC sequence, and at least one of the length of the first sequence or the length of the second sequence meets at least one of the following:
$${L}_{ZC} = {2}^{k} / M , wherein {2}^{k} \leq 12 * X ; or {L}_{Z C} = \frac{2 * X}{M} ,$$
wherein
M is the modulation order of the first signal and/or the modulation order of the second signal, and X is at least one of the number of transmission resource blocks of the first signal or the number of transmission resource blocks of the second signal.

17. The method according to claim 15, wherein there is a second association relationship between the length of the first sequence and the modulation order of the first signal, and the second association relationship indicates at least one of following:
a modulation order of one first signal being corresponding to lengths of a plurality of first sequences;
modulation orders of a plurality of first signals being corresponding to a length of one first sequence; or
a modulation order of one first signal being corresponding to a length of one first sequence.

18. The method according to claim 1, wherein at least one of a power of the first signal or a power of the second signal is allocated based at least one of following:
an activated subcarrier;
symbol positions of the OFDM; or
a peak-to-average power ratio PAPR detection result.

19. The method according to claim 18, wherein at least one of the power of the first signal or the power of the second signal is uniformly distributed on the activated subcarrier.

20. The method according to claim 18, wherein a power of a symbol frame used for transmitting the first signal or a power of a symbol frame used for transmitting the second signal is determined based on p=α*p′+(1−α)*Pₜₒₜₐₗ/Nₒₙ, wherein
p is the power of the symbol frame used for transmitting the first signal or the power of the symbol frame used for transmitting the second signal, a is a smoothing factor, p′ is a power of a previous symbol frame, pₜₒₜₐₗ is at least one of a total power of the first signal or a total power of the second signal, and Nₒₙ is a number of activated subcarriers.
